(19) United States
(12) Patent Application Publication
(10) Pub. No.: US 2025/0336126 A1
(43) Pub. Date: Oct. 30, 2025

(54) TECHNIQUES FOR REMOVING CONTENT FROM WEBPAGES

(71) Applicant: Apple Inc., Cupertino, CA (US)

(72) Inventors: Wenson HSIEH, Pleasanton, CA (US); Beth M. DAKIN, San Jose, CA (US); Charles H. YING, San Mateo, CA (US); Charles J. WOLFE, San Francisco, CA (US); Kuanhsiang S. HUANG, Sunnyvale, CA (US); Maciej STACHOWIAK, San Francisco, CA (US); Matthew R. GILLIGAN, San Francisco, CA (US); Razvan CALIMAN, Amsterdam (NL); Steven J. FALKENBURG, Los Altos, CA (US); Yongjun ZHANG, Sunnyvale, CA (US)

(21) Appl. No.: 19/089,416

(22) Filed: Mar. 25, 2025

Related U.S. Application Data
(60) Provisional application No. 63/640,829, filed on Apr. 30, 2024.
(60) Provisional application No. 63/657,847, filed on Jun. 8, 2024.

(51) Int. Cl. G06T 11/60; G06F 16/957; G06V 30/19; G06V 30/42

(52) U.S. Cl. CPC G06T 11/60; G06F 16/957; G06V 30/19; G06V 30/42; G06T 2200/24

(57) ABSTRACT

A method includes, by a web browsing application, receiving an input identifying unwanted content of a first webpage to be erased from display on a user interface, storing user preference data identifying the unwanted content, identifying, based on the unwanted content, visual content corresponding to the unwanted content, and preventing, at a visual rendering layer of the web browsing application, display of the visual content corresponding to the unwanted content. Preventing display of the visual content includes one of preventing the display of the visual content without modifying, in underlying layers of the web browsing application, code associated with display of the unwanted content, or storing, in one or more of the underlying layers, data instructing the web browsing application to prevent the display of the visual content.

### CROSS-REFERENCE TO RELATED APPLICATIONS

The present application claims priority to U.S. Provisional Patent Application Ser. No. 63/657,847, entitled “TECHNIQUES FOR REMOVING CONTENT FROM WEBPAGES” filed Jun. 8, 2024, and to U.S. Provisional Patent Application Ser. No. 63/640,829, entitled “TECHNIQUES FOR REMOVING CONTENT FROM WEBPAGES” filed Apr. 30, 2024, which are hereby incorporated by reference in their entireties for all purposes.

### FIELD

The described embodiments relate generally to managing operational aspects of a web browser relative to user content preferences. More particularly, the described embodiments provide techniques for implementing a user-defined content block list. The described embodiments also provide techniques for blocking, hiding, etc., content in a manner that substantially mitigates detection by an entity providing the content.

### BACKGROUND

In the era of digital technology, web browsers have become an essential tool for accessing online resources. However, users are typically provided with unwanted content while browsing. Unwanted content may include, for example, advertisements and other types of popups, autoplay videos, cookie banners and consent notices, third-party sign-in options, and the like.

Some web browsers may include or may be modified to include features configured to block different types of content. As one example, many web browsers have features such as ad-blockers that prevent websites from displaying intrusive ads or other content. However, an entity providing the content (e.g., an entity hosting or otherwise associated with a website or webpage) may be aware that the content is being blocked by the user. The entity may be adversarial with the respect to the blocking of the content, and, in some examples, may attempt to circumvent the blocking of the content or even retaliate against the user.

### SUMMARY

The described embodiments relate generally to techniques for blocking, hiding, etc., content in a manner that substantially mitigates detection by an entity providing the content.

One embodiment sets forth a method for blocking, hiding, etc., content identified by a user via a web browser application executing on a computing device. According to some embodiments, the method can be implemented by the web browser application.

In an embodiment, a method includes, by a web browsing application, receiving an input identifying unwanted content of a first webpage to be erased from display on a user interface, storing user preference data identifying the unwanted content, identifying, based on the unwanted content, visual content corresponding to the unwanted content, and preventing, at a visual rendering layer of the web browsing application, display of the visual content corresponding to the unwanted content. Preventing display of the visual content includes one of preventing the display of the visual content without modifying, in underlying layers of the web browsing application, code associated with display of the unwanted content, or storing, in one or more of the underlying layers, data instructing the web browsing application to prevent the display of the visual content.

Other embodiments include a non-transitory computer readable storage medium configured to store instructions that, when executed by a processor included in a computing device, cause the computing device to carry out the various steps of any of the foregoing methods. Further embodiments include a computing device that is configured to carry out the various steps of any of the foregoing methods.

Other aspects and advantages of the invention will become apparent from the following detailed description taken in conjunction with the accompanying drawings that illustrate, by way of example, the principles of the described embodiments.

### BRIEF DESCRIPTION OF THE DRAWINGS

The disclosure will be readily understood by the following detailed description in conjunction with the accompanying drawings, wherein like reference numerals designate like structural elements.

FIG. 1 illustrates a system diagram of a computing device that can be configured to perform the various techniques described herein, according to some embodiments.

FIGS. 2A-2D illustrate conceptual diagrams of a user interface that can be displayed by a web browser application configured to implement content blocking techniques, according to some embodiments.

FIG. 3 illustrates a method for blocking, hiding, etc., unwanted content via a web browser application executing on a computing device, according to some embodiments.

FIGS. 4A-4B further illustrate conceptual diagrams of a user interface that can be displayed by a web browser application configured to implement content blocking techniques, according to some embodiments.

FIG. 5 illustrates another method for blocking, hiding, etc., unwanted content via a web browser application executing on a computing device, according to some embodiments.

FIG. 6 illustrates a detailed view of a computing device that can be used to implement the various techniques described herein, according to some embodiments.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

In the following detailed description, references are made to the accompanying drawings, which form a part of the description, and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

The embodiments described herein enable users to select various content in webpages to be removed, or hidden—also referred to herein as “erasing”—from the webpages when the webpages are displayed or rendered by a web browser application. In some embodiments, the selected content is removed from the webpage and/or hidden from the user's view in the web browser during future browser sessions. The erase option thus allows the user to customize, for a particular webpage (e.g., without necessarily applying the customization to other webpages that display similar content and/or content related to the erased content), which content (e.g., ad slots, banners, and/or other content) is to be hidden from the user's view. Such user customization may be limited to selections explicitly made by the user, where software (e.g., a browser assistant) will not proactively predict and select content for removal. In some embodiments, the user selects locations and/or other types of defined user interface objects within a webpage to be hidden for that webpage (e.g., the selected content does not correspond to a topic, subject and/or ideas expressed by the content to be erased). In this regard, the user's selection of content may not necessarily target particular advertisements, advertisers, topics and/or subjects. Moreover, enabling the user to remove content from respective webpages improves the web browsing experience of the user without tracking the user's selection of content to be removed (e.g., the privacy of the user is maintained without tracking the topics, subjects, and/or ideas associated with the respective content that have been erased or hidden from the user's view).

Representative embodiments disclosed herein set forth various techniques for managing operational aspects of a web browser relative to user content preferences (e.g., preferences related to selective blocking of specific content). More particularly, the described embodiments provide content blocking techniques for implementing a user-defined content block list. As used herein, the terms “block” or “blocking” may refer to hiding or otherwise preventing the display of content. The content blocking techniques include blocking, hiding, erasing, etc., content in a manner that substantially mitigates detection by an entity providing the content (e.g., by a script being executed by a corresponding webpage), thereby preventing circumvention, retaliation, etc., by the entity. As used herein, the terms “block,” “hide,” and “erase” may be used interchangeably. In some examples, functionality described herein may be referred to as a “web eraser.”

For example, the user may identify, while viewing a webpage, unwanted content via one or more inputs (e.g., mouse clicks, touch inputs, keyboard inputs, etc.), causing the content to be “erased” or blocked from the user's view. The content identified by the user may be stored as user preference data and automatically hidden from the user's view during subsequent browsing of the webpage and other webpages including the same or similar content. In an example, content blocking techniques according to the present disclosure are implemented in a “painting” layer or stage of webpage presentation. Generally, painting refers to a final stage of rendering and displaying webpage content to the user. During painting, the web browser converts webpage code into displayed visual components or content (e.g., pixels). Content blocking techniques as described herein prevent painting/rendering of visual components corresponding to content identified by the user. Accordingly, content blocking techniques as described herein may be referred to as “area-based paint avoidance.”

As used herein, the painting layer (or other visual rendering layer) is distinguished from other, underlying layers of a web browser application, including layers executed by a client-side device and/or server-side device. Underlying layers, as used herein, may refer to client-side layers such as a presentation layer, a document object model (DOM) layer, a JavaScript engine, and so on, as well as server-side layers such as an application layer and a data layer. Preventing presentation of visual components or content in accordance with the content blocking techniques does not affect or interfere with execution of the underlying webpage code of one or more underlying layers, such as processes executed in/by the presentation layer, DOM layer, JavaScript engine, application layer, and/or data layer. Accordingly, any method or process implemented by the webpage to detect blocking of the content and visibility to the user (e.g., a script or other programming feature) is still executed by the webpage. In other words, the entity providing the content likely will be unaware that the content is not being displayed to the user. In this regard, the likelihood of subsequent circumvention, retaliation, etc., by the entity is reduced.

The user preference data (which may be stored locally on one or more user or client devices 108, shared between client devices, and so on) includes a list of content blocked by the user. The content blocking techniques include blocking specific content identified by the user preference data, identifying and blocking content similar to the blocked content during subsequent browsing, and updating or evolving the list of content over time as new content is added by the user and other content similar to the blocked content is identified. As one example, content blocking techniques as described herein include implementing one or more content detection and recognition techniques to detect whether content that has been previously blocked by the user has returned to a webpage (e.g., in a modified form, as the same content in a different location on the webpage, etc.). For example, edit-distance-based heuristics may be used to compare snapshots of rendered text from previously blocked content to current content that exists in a same location as the previously blocked content and/or to current content in other locations. The content blocking techniques described herein include automatically updating the user preference data (e.g., a rules list or other content blocking parameters) upon detection of similar content in a same location, the same content in a different location, and so on. In some examples, content detection and recognition techniques may include using optical character recognition (OCR).

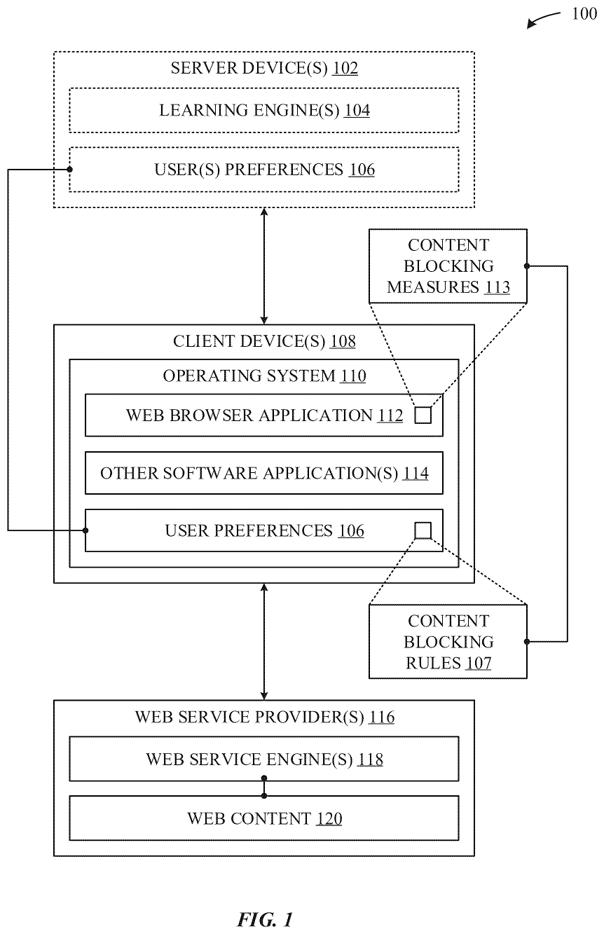

FIG. 1 illustrates a block diagram of different components of a system 100 that can be configured to implement the various techniques described herein, according to some embodiments. As shown in FIG. 1, the system 100 can include (optional) one or more server devices 102, one or more client devices 108, and one or more web service providers 116. According to some embodiments, a given server device 102 can (optionally) include one or more learning engines 104, which are described below in greater detail. Additionally, the server device 102 can (optionally) manage user preferences 106 for any number of users. For example, the server devices 102 can provide cloud-based backups of the user preferences 106, distributions of the user preferences 106 to associated/respective client devices 108, and so on. As described herein, the user preferences 106 can guide the manner in which content blocking techniques are implemented relative to browsing actions performed using the client devices 108.

According to some embodiments, and as shown in FIG. 1, a given web service provider 116 can include one or more web service engines 118 configured to provide web content 120. For example, a given web service engine 118 can host a website derived from the web content 120. In another example, a given web service engine 118 can host a service that streams content that is stored within the web content 120. It is noted that the foregoing examples are not meant to be limiting, and that the web service providers 116 can provide any form of network-based functionality, consistent with the scope of this disclosure.

According to some embodiments, and as shown in FIG. 1, a given client device 108 can manage (i.e., store, load, execute, etc.) an operating system 110 configured to execute a web browser application 112, as well as other software applications 114 (e.g., software applications native to the operating system 110, third-party software applications installed onto the operating system 110 (e.g., via a Software Application Store (i.e., “App Store”), via over the air provisioning, via side loading, etc.), and so on). The operating system 110 can also manage the user preferences 106 previously discussed herein. For example, the user preferences 106 can be established and managed by one or more of the operating system 110, the web browser application 112, the other software application(s) 114, and so on. The user preferences 106 can, optionally, be provided to one or more server devices 102 (e.g., during a cloud backup service).

As a brief aside, it is noted that the embodiments described herein primarily involve web browser applications (i.e., the web browser application 112) in the interest of simplifying this disclosure. However, the same (or similar) techniques can be implemented in any software application, consistent with the scope of this disclosure. For example, a web services application—such as a streaming client configured to stream media content from server devices—can implement the same (or similar) features of the web browser application 112 described herein. In other examples, the same (or similar techniques) can be implemented by operating systems, productivity applications, multimedia applications, gaming applications, utility applications, communications applications, education applications, finance applications, health applications, and so on. It is further noted that the terms “website” and “webpage” can represent a single webpage, or multiple webpages, associated with a particular domain, URL, and so on.

As shown in FIG. 1, the web browser application 112 can be configured to implement different content blocking techniques or measures 113 when users utilize the web browser application 112 to access different network-based services (e.g., those offered by the web service providers 116), such as webpage browsing. The content blocking measures 113 can include, for example: receiving one or more inputs identifying unwanted content being displayed to the user while the user is viewing a webpage; erasing the unwanted content from the webpage in a manner that substantially mitigates detection by an entity providing the content; storing a user-defined block list that identifies the unwanted content; during subsequent browsing, detecting the unwanted content or content similar to the unwanted content identified in the user-defined block list; blocking/preventing display of the unwanted content; and updating the user-defined block list in response to identifying content similar to the unwanted content.

It is noted that the foregoing examples are not meant to be limiting, and that the content blocking measures 113 can involve adjusting various aspects of the manner in which the web browser application 112 interacts with network-based services, at any level of granularity, consistent with the scope of this disclosure. According to some embodiments, the content blocking measures 113 can be derived from, stored within, etc., content blocking rules 107 managed in conjunction with the user preferences 106.

The web browser application 112 can register, within the user preferences 106 (e.g., stored in a local storage device, a network storage device, a cloud storage service, etc.), a content blocking rule 107 that associates the content blocking measures 113 with identifying information of the webpage. For example, the entry can include domain information, Internet Protocol (IP) address information, etc., of the website, as well as information that enables the modified content blocking measures 113 to be reconfigured/reapplied while accessing the website.

The web browser application 112 according to the present disclosure is configured to implement various content blocking techniques by executing one or more of the content blocking measures 113 in accordance with the user preferences 106, and in particular in accordance with the content blocking rules 107. The content blocking measures 113 are configured to block or hide content in a manner that substantially mitigates detection by an entity providing the content (e.g., an entity providing and/or hosting a webpage comprising or derived from the web content 120).

In an example, the web browser application 112 may receive identification of unwanted content (e.g., via one or more inputs, such as mouse clicks, finger taps or touches, etc.) received from a user of the client device 108. For example, the user may identify the unwanted content while viewing the webpage, causing the web browser application 112 to erase the unwanted content from the user's view. As an example, the web browser prevents rendering/display of the unwanted content on the client device 108. The content identified by the user may be stored as user preference data (e.g., in the user preferences 106) and automatically hidden from the user's view during subsequent browsing of the webpage and other webpages including similar content.

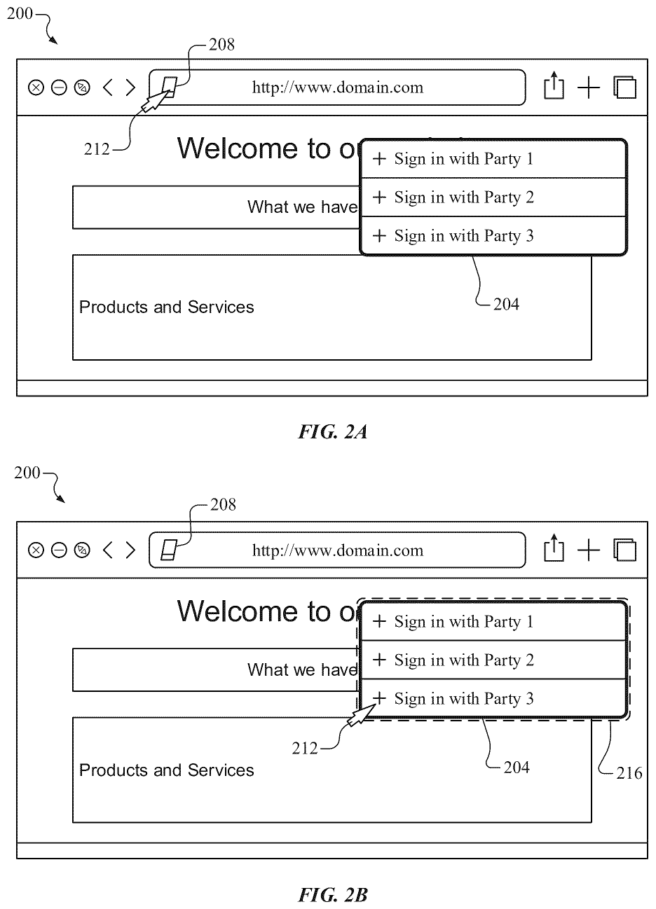

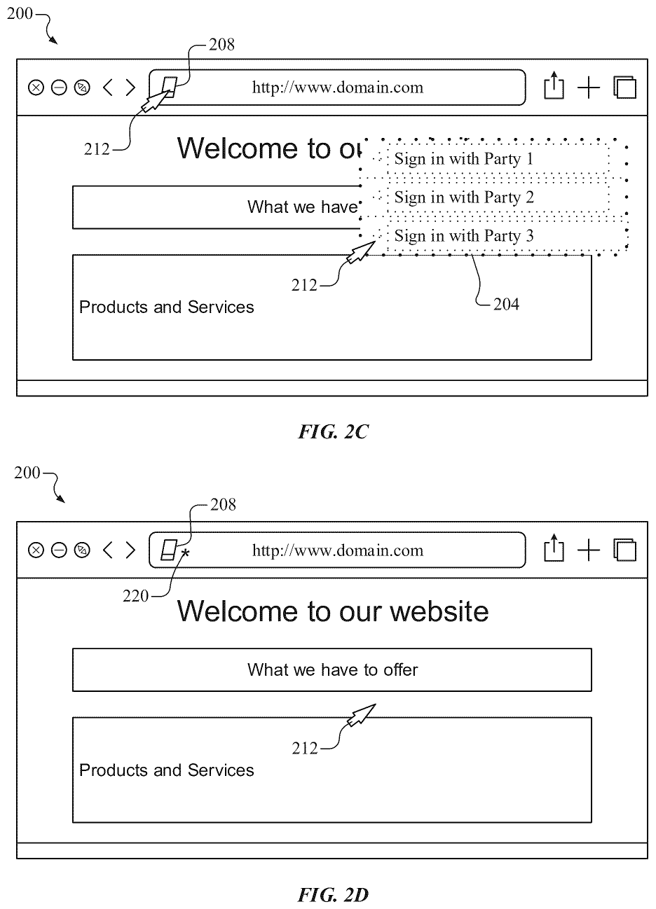

One example implementation of the identification and blocking of unwanted content is described with respect to FIGS. 2A-2D, with continued reference to FIG. 1. FIGS. 2A-2D illustrate conceptual diagrams of a user interface 200 that can be displayed by the web browser application 112 when viewing a webpage or other web content, according to some embodiments. As shown in FIG. 2A, the web browser application 112 is operating in an initial state upon loading the webpage (e.g., a webpage corresponding to an example URL such as, as shown in FIGS. 2A-2D, “http://www.domain.com”).

While accessing the webpage, the user may be provided with unwanted content, such as a third-party sign-in popup 204. In other examples, the unwanted content may include, advertisements, autoplay videos, cookie banners and consent notices, and so on. The web browser application 112 includes the option to erase/block the popup 204 from the user's view. In an example, the web browser application 112 displays an erase icon or button 208. The user activates an erase function by clicking a mouse button while hovering over the erase button 208 with a cursor 212, tapping the erase button 208 with a finger (e.g., when the user interface 200 corresponds to a touchscreen interface), or providing other suitable inputs.

Once the erase function is activated, the one or more graphical elements corresponding to unwanted content may be selected and erased from the user interface 200. As shown in FIG. 2B, with the erase function activated, the user selects the popup 204. As one example, the user clicks the mouse button while hovering over the popup 204 with the cursor 212. In some examples, the popup 204 may be highlighted, outlined, etc. (e.g., outlined with a selection box 216 or other indicator) to identify the content selected by the user. In this manner, the user is provided with notification of the content that will be erased.

FIG. 2C shows the user interface 200 upon selection of the popup 204 for erasure. For example, the popup 204 may be erased using various visual effects, such as pixilation or dissolving effects (as shown), fading effects, wiping effects, and so on. FIG. 2D shows the user interface 200 subsequent to erasure of the popup 204. In some examples, the user interface 200 may display an indicator (e.g., a star or other icon 220 adjacent to the erase button 208) indicating that content has been erased from the webpage. For the duration of a current visit and for subsequent visits to the webpage, the popup 204 will remain erased and hidden from the user's view, and the icon 220 will provide an indication that content has been erased from the webpage. In some examples, selecting the icon 220 may cause the user interface 200 to display a list of content blocked on the webpage, options to unblock content, and so on.

The content blocking techniques described in FIGS. 2A-2D may be performed in a “painting” layer or stage of webpage presentation. Generally, painting refers to a final stage of rendering and displaying webpage content to the user via the user interface 200. During painting, the web browser application 112 converts webpage code into displayed visual components (e.g., pixels) visible to the user via the user interface 200. Content blocking techniques as described herein prevent painting/rendering of visual components corresponding to content identified by the user. Accordingly, content blocking techniques as described herein may be referred to as “area-based paint avoidance.”

In an example, the web browser application 112 is configured to identify visual components of underlying code identified by the user. For example, when the user selects content such as the popup 204, the web browser application 112 analyzes the underlying code of the webpage to identify the visual elements displayed in the corresponding region of the user interface 200. More specifically, the web browser application 112 differentiates between (i) visual content obscured by (i.e., behind, and therefore not currently being visually rendered) the popup 204 at the time that the user has selected the popup 204 and (ii) visual content actually being rendered and displayed on the user interface 200. The web browser application 112 then “erases” the visual content corresponding to the popup 204 by preventing display of the visual content. As used herein, “erasing” may correspond to displaying, instead of the erased content, the content of the underlying webpage (i.e., the visual content of the webpage obscured by the popup 204). The user is subsequently unable to interact with/prevented from interacting with the erased content.

Preventing presentation of visual components or content in this manner does not affect or interfere with execution of the underlying webpage code (e.g., code associated with display of the content). For example, although the visual content corresponding to the erased popup 204 is not displayed via the user interface, the underling code/content continues to function. For example, geometry, bounding boxes, position, and other parameters associated with the popup 204, including any scripts executed by/on the webpage, are not changed or interrupted in response to the web browser application 112 preventing the painting of the corresponding visual content. Accordingly, any method or process implemented by the webpage to detect blocking of the content and visibility to the user (e.g., a script or other programming feature) is still executed by the web webpage, including aspects executed by the web browser application 112. In other words, the entity providing the content is unaware that the content is not being displayed to the user via the user interface 200 and the likelihood of subsequent circumvention or retaliation by the entity is reduced.

As one example, the web browser application 112 prevents execution of rendering of the visual content at the painting layer without making any modifications to any underlying layers (e.g., the DOM layer). For example, the web browser application 112 is configured to, based on the content blocking rules 107, identify visual content (e.g., as indicated in corresponding DOM layer) previously identified as unwanted content and simply refrain from rendering the visual content. In other examples, the web browser application 112 is configured to modify one or more of the underlying layers in a manner that does not interfere with execution of those layers but informs the web browser application 112 to refrain from visually rendering (i.e., at the painting layer) corresponding visual content. For example, in response to receiving an identification of unwanted content, one or more flags may be set in the DOM layer. The flags may function as flags or identifiers of the unwanted content. Rules for implementing the flags may be stored by the web browser application (e.g., within the content blocking measures 113, the content blocking rules 107 and/or other user preferences 106, and so on). During subsequent browsing, the flags may be retrieved and added to a webpage having unwanted content previously blocked by the user and the web browser application 112 blocks display of corresponding visual content upon detection of the flags. Although flags are described as one example, other types of data or indicators may be stored in one or more of the underlying layers to instruct the web browser application 112 to block (i.e., not visually render) unwanted content.

The user preferences 106 include a list of content blocked by the user, which may be contained in the content blocking rules 107. The content blocking measures 113 include blocking specific content identified by the content blocking rules 107, identifying and blocking content similar to the blocked content during subsequent browsing, and updating or evolving the list of content over time as new content is added by the user and other content similar to the blocked content is identified by the web browser application. As one example, content blocking measures 113 as described herein include implementing one or more content detection and recognition techniques to detect whether content that has been previously blocked by the user has returned to a webpage (e.g., in a modified form, as the same content in a different location on the webpage, etc.). For example, the web browser application 112 may use edit-distance-based heuristics to compare snapshots of rendered text from previously blocked content to current content that exists in a same location as the previously blocked content. The content blocking measures 113 may include automatically updating the content blocking rules 107 upon detection of similar content in a same location (i.e., a same location in the user interface 200), the same content in a different location (e.g., the popup 204 displayed in a different location in the user interface 200 and/or on a different webpage), and so on.

In some examples, the web browser application 112 is configured to perform content detection and recognition techniques by using optical character recognition (OCR). For example, the web browser application 112 may be configured to determine whether to block content based in part on text contained in a region selected by the user. However, in some examples, selected content may correspond to a displayed image or other element. Accordingly, the web browser application 112 may be configured to perform OCR techniques to identify and extract text from an image in content selected by the user and block content during subsequent browsing based on a comparison between the identified text and similar text in other content. Conversely, the web browser application 112 may be configured to perform OCR techniques to identify and extract text from images displayed during subsequent browsing (e.g., in content displayed in a same area of the user interface 200 including content that the user has previously blocked), compare the extracted text to previously blocked content in a user-defined block list, and selectively block additional content in response to determining that the extracted text is the same as or similar to the previously blocked content.

Accordingly, the web browser application 112 is configured to analyze various visual features of both the blocked content and later-displayed/browsed content encountered by the user, including, but not limited to, actual text content, visual features of the text and other content, geometry of the content, position of the content, cascading style sheets (CSS) properties of the content (e.g., CSS paths/vectors associated with the content), and so on.

As described herein, the server devices 102 can include one or more of the learning engines 104. According to some embodiments, the learning engines 104 can be trained using information received from client devices 108 (or other devices) that have opted-in to participate in a feedback program. According to some embodiments, the information can be anonymized (e.g., by the client devices 108 prior to transmission, by the server devices 102 in conjunction with receipt, etc.) such that the information does not include data that otherwise could be linked to specific users. For example, the anonymized information can include (only) (1) information associated with a particular network-based service (e.g., a domain of a webpage), (2) information about the content blocking measures 113 that were in place when access to the network-based service was attempted, (3) information about the issues that were reported by a user and/or detected by the web browser application 112, and so on. It is noted that the foregoing list is not meant to be exhaustive, and that the anonymized information can include any amount, form, type, etc., of information, at any level of granularity, consistent with the scope of this disclosure.

In some examples, the server devices 102 can provide configurational guidance to the web browser applications 112 so that the users' overall experience can be enhanced. For example, the web browser application 112 can receive the configurational guidance and store it into the user preferences 106/content blocking rules 107 (or other configuration store accessible to the web browser applications 112). In this manner, when a given web browser application 112 receives a request to access a webpage, the web browser application 112 can, prior to loading the webpage, suggest (e.g., via a GUI prompt) applying the content blocking measures 113, automatically apply the content blocking measures 113, and so on.

It should be understood that the various components of the computing devices illustrated in FIG. 1 are presented at a high level in the interest of simplification. For example, although not illustrated in FIG. 1, it should be appreciated that the various computing devices can include common hardware/software components that enable the above-described software entities to be implemented. For example, each of the computing devices can include one or more processors that, in conjunction with one or more volatile memories (e.g., a dynamic random-access memory (DRAM)) and one or more storage devices (e.g., hard drives, solid-state drives (SSDs), etc.), enable the various software entities described herein to be executed. Moreover, each of the computing devices can include communications components that enable the computing devices to transmit information between one another.

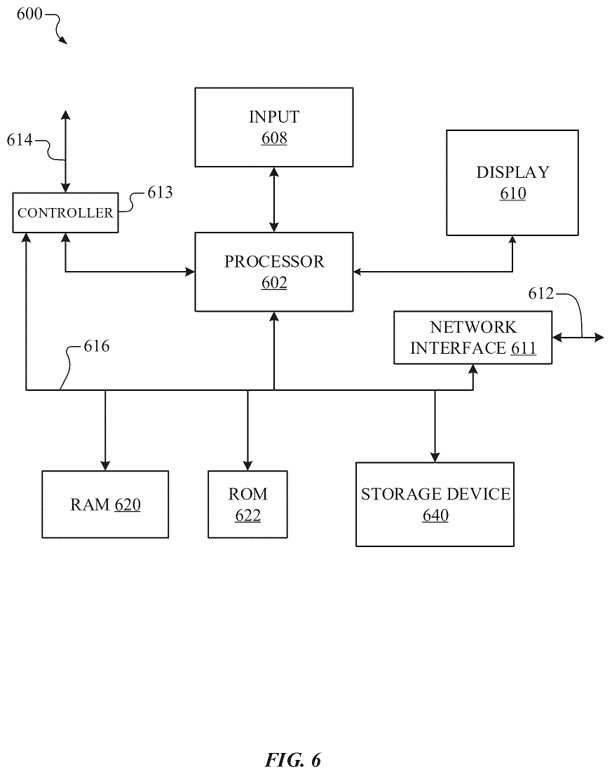

A more detailed explanation of these hardware components is provided below in conjunction with FIG. 6. It should additionally be understood that the computing devices can include additional entities that enable the implementation of the various techniques described herein, consistent with the scope of this disclosure. It should additionally be understood that the entities described herein can be combined or split into additional entities, consistent with the scope of this disclosure. It should further be understood that the various entities described herein can be implemented using software-based or hardware-based approaches, consistent with the scope of this disclosure.

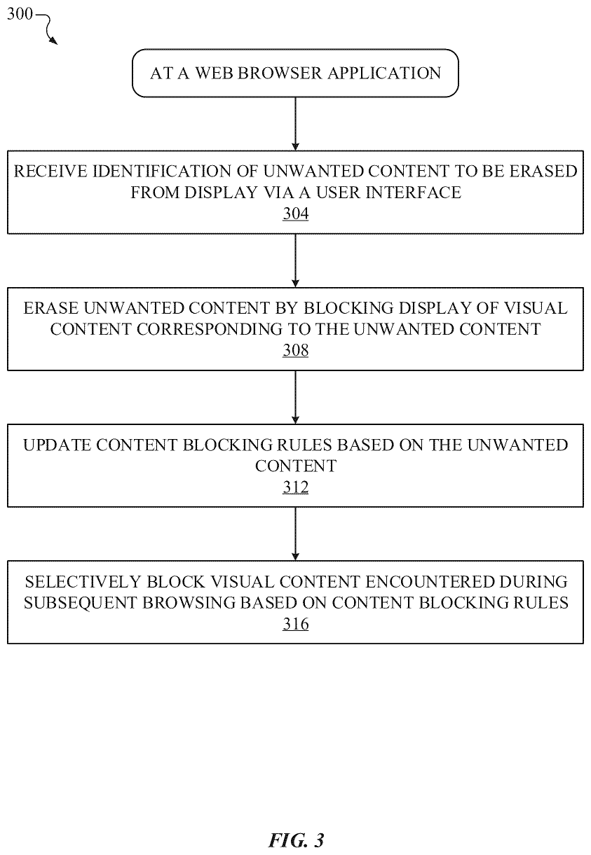

FIG. 3 illustrates a method 300 for providing user interfaces for blocking, hiding, etc., unwanted content associated with a web browser application executing on a computing device, according to some embodiments. As shown in FIG. 3, the method 300 begins at step 304, where the web browser application 112 receives an identification of unwanted content to be erased from display via the user interface 200. At 308, the web browser application 112 erases the unwanted content from display. For example, the web browser application 112 identifies visual content (i.e., content that is actually displayed/rendered via the user interface 200) corresponding to the unwanted content and blocks display/rendering of the visual content. As described herein, blocking of the visual content is implemented in a visual rendering layer (“a painting layer”) of the web browser application in a manner that is not detectable by the entity providing the unwanted content. At 312, the web browser application 112 updates a user-defined block list (e.g., content blocking rules 107) based on the unwanted content. At 316, the web browser application 112, during subsequent browsing, selectively blocks visual content (e.g., on the same webpage or a different webpage) based on the content blocking rules 107 and characteristics of content encountered during the subsequent browsing.

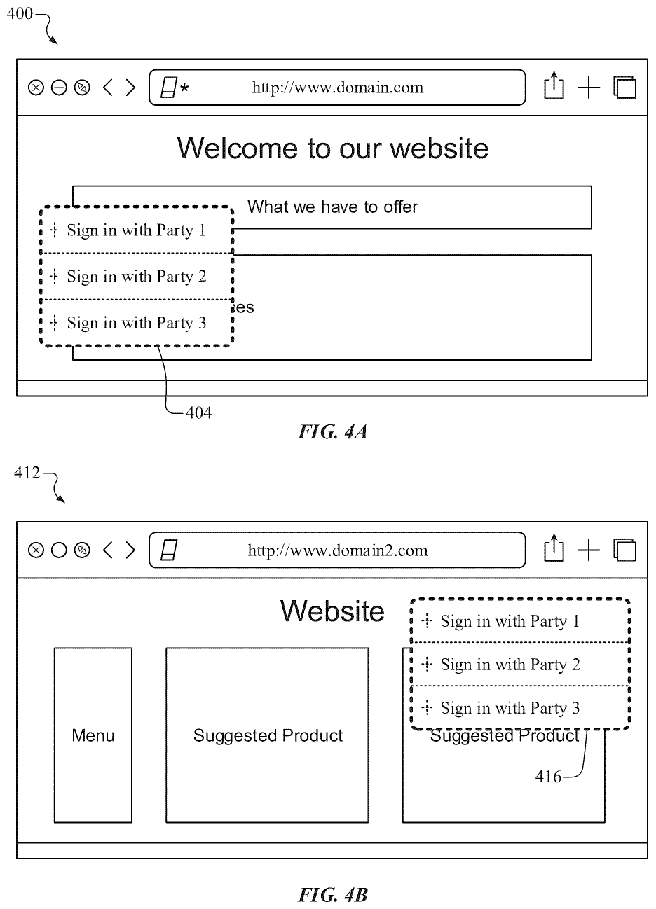

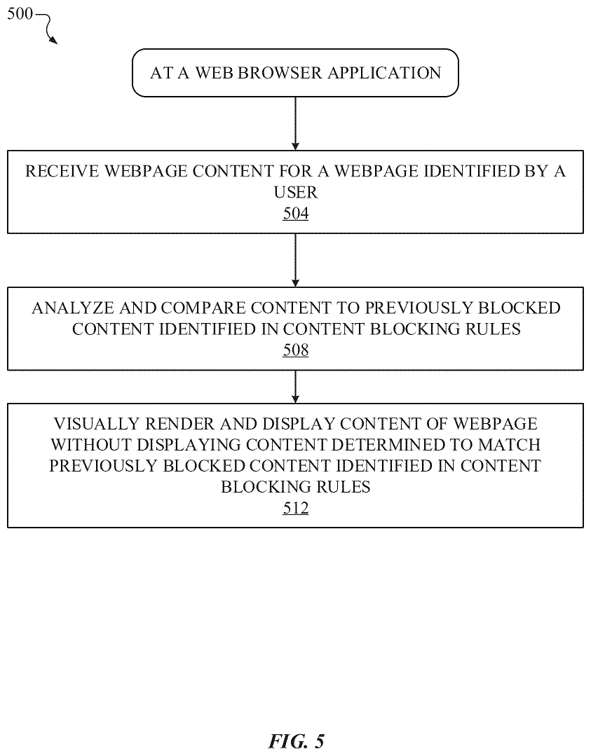

Another example implementation of the identification and blocking of unwanted content is described with respect to FIGS. 4A-4B, with continued reference to FIG. 1. FIG. 4A illustrates a conceptual diagram of a user interface 400 that can be displayed by the web browser application 112 when viewing a webpage or other web content, according to some embodiments. As shown in FIG. 4A, the user interface 400 corresponds to the user interface 200 in a subsequent visit (e.g., subsequent to the user blocking the popup 204 in a previous visit).

As described herein, the content blocking measures 113 are configured to detect whether content that has been previously blocked by the user has returned to a webpage in a modified form, in a different location, etc. The content blocking measures 113 may include automatically updating the content blocking rules 107 upon detection of similar content in a same location, detection of the same content in a different location, detection of similar content in a different location, and so on.

As shown in FIG. 4A, a popup 404 is similar to the popup 204 but in a different location. For example, the popup 404 may have a different size, shape, color, and/or font, and may have different content (e.g., fewer or more third-party sign in options). However, the web browser application 112 is configured to implement one or more content detection and recognition techniques to determine whether the popup 404 includes content that has been previously blocked by the user and block the popup 404 upon subsequent visits to the webpage. For example, during loading of the webpage, the web browser application 112 analyzes the webpage, compares content contained in various layers of the webpage to content identified in the content blocking rules 107, and blocks any content from being displayed that matches content identified in the content blocking rules 107. In one example, the web browser application 112 uses edit-distance-based heuristics to compare snapshots of rendered text from previously blocked content to current content in the webpage. In some examples, the web browser application 112 compares non-text content (e.g., images or graphical elements) from the previously blocked content to current content in the webpage. In other examples, the web browser application 112 implements OCR or other content recognition techniques to extract text from the current content and compare the text to content identified in the content blocking rules 107. In still other examples, the web browser application 112 is configured to compare various other visual features of the current content to the content identified by the content blocking rules, such as geometry, position, CSS properties of the content, and so on.

Although the popup 404 is visible in FIG. 4A, the popup 404 is shown (e.g., in dashed lines) simply for illustration purposes. In other words, when presented on the user interface 400, the webpage may not include the visual elements of the popup 404 due to being preemptively blocked by the web browser application 112. For example, the popup 404 may not be displayed due to the web browser application 112 determining that the visual content corresponding to the popup 404 matches previously blocked content identified in the content blocking rules 107 and preventing execution of rendering of the visual content corresponding to the popup 404. In other examples, the web browser application 112 may determine that the popup 404 does not match any content identified in the content blocking rules 107 and allow display of the popup 404. In these examples, if the user subsequently blocks the popup 404, the web browser application 112 updates the content blocking rules 107 to include the popup 404.

In another example shown in FIG. 4B, a user interface 412 displays a webpage corresponding to an example URL such as “http://www.domain2.com.” In other words, the user interface 412 is displaying a webpage from a URL different than that shown in FIGS. 2A-2D but may include a popup 416 similar to the popups 204 and 404. However, while loading the webpage and prior to displaying the popup 416, the web browser application 112 analyzes the webpage, compares content contained in various layers of the webpage to content identified in the content blocking rules 107, and blocks any content from being displayed that matches content identified in the content blocking rules 107, including visual content corresponding to the popup 416 as described herein.

FIG. 5 illustrates another method 500 for providing user interfaces for blocking, hiding, etc., unwanted content associated with a web browser application executing on a computing device, according to some embodiments. As shown in FIG. 5, the method 500 begins at step 504, where the web browser application 112 receives webpage content corresponding to a URL or domain name identified by the user. For example, the web browser 112 receives a request to navigate to a webpage or domain name identified by the user (e.g., via a clicked link, shortcut, favorite button, etc.), establishes a connection with a server at an internet protocol (IP) address corresponding to the website, sends a request to the server to request content of the webpage, and receives the content for processing and display.

At 508, the web browser application 112 analyzes and compares the content to determine whether any of the content matches previously blocked content identified in the content blocking rules. For example, analyzing the content may include, but is not limited to, parsing code (HTML code, JavaScript, and so on), constructing the DOM and/or other layers of the webpage based on the code, and identifying images, stylesheets, scripts, and/or CSS properties.

At 512, the web browser application 112 blocks (i.e., does not visually render) any of the visual content of the webpage that matches content identified in the content blocking rules 107. For example, the web browser application 112 performs rendering and display of the webpage based on the contents of the DOM and/or other layers of the webpage while omitting/preventing display of any visual content that was determined to match any content identified in the content blocking rules.

FIG. 6 illustrates a detailed view of a computing device 600 that can be used to implement the various techniques described herein, according to some embodiments. In particular, the detailed view illustrates various components that can be included in the server devices 102, client devices 108, and web service providers 116 described in conjunction with FIG. 1. As shown in FIG. 6, the computing device 600 can include a processor 602 that represents a microprocessor or controller for controlling the overall operation of the computing device 600. The computing device 600 can also include a user input device 608 that allows a user of the computing device 600 to interact with the computing device 600. For example, the user input device 608 can take a variety of forms, such as a button, keypad, dial, touch screen, audio input interface, visual/image capture input interface, input in the form of sensor data, and so on. Still further, the computing device 600 can include a display 610 that can be controlled by the processor 602 (e.g., via a graphics component) to display information to the user. A data bus 616 can facilitate data transfer between at least a storage device 640, the processor 602, and a controller 613. The controller 613 can be used to interface with and control different equipment through an equipment control bus 614. The computing device 600 can also include a network/bus interface 611 that couples to a data link 612. In the case of a wireless connection, the network/bus interface 611 can include a wireless transceiver.

As noted above, the computing device 600 also includes the storage device 640, which can comprise a single disk or a collection of disks (e.g., hard drives). In some embodiments, storage device 640 can include flash memory, semiconductor (solid-state) memory or the like. The computing device 600 can also include a Random-Access Memory (RAM) 620 and a Read-Only Memory (ROM) 622. The ROM 622 can store programs, utilities, or processes to be executed in a non-volatile manner. The RAM 620 can provide volatile data storage, and stores instructions related to the operation of applications executing on the computing device 600.

The various aspects, embodiments, implementations, or features of the described embodiments can be used separately or in any combination. Various aspects of the described embodiments can be implemented by software, hardware or a combination of hardware and software. The described embodiments can also be embodied as computer readable code on a computer readable medium. The computer readable medium is any data storage device that can store data that can be read by a computer system. Examples of the computer readable medium include read-only memory, random-access memory, CD-ROMs, DVDs, magnetic tape, hard disk drives, solid state drives, and optical data storage devices. The computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

The terms “a,” “an,” “the,” and “said” as used herein in connection with any type of processing component configured to perform various functions may refer to one processing component configured to perform each and every function, or a plurality of processing components collectively configured to perform each of the various functions. By way of example, “A processor” configured to perform actions A, B, and C may refer to one or more processors configured to perform actions A, B, and C. In addition, “A processor” configured to perform actions A, B, and C may also refer to a first processor configured to perform actions A and B, and a second processor configured to perform action C. Further, “A processor” configured to perform actions A, B, and C may also refer to a first processor configured to perform action A, a second processor configured to perform action B, and a third processor configured to perform action C.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

What is claimed is:

1. A method, comprising, by a web browsing application:
receiving an input identifying unwanted content of a first webpage to be erased from display on a user interface;
storing user preference data identifying the unwanted content;
identifying, based on the unwanted content, visual content corresponding to the unwanted content; and
preventing, at a visual rendering layer of the web browsing application, display of the visual content corresponding to the unwanted content, wherein preventing display of the visual content includes one of (i) preventing the display of the visual content without modifying, in underlying layers of the web browsing application, code associated with display of the unwanted content, or (ii) storing, in one or more of the underlying layers, data instructing the web browsing application to prevent the display of the visual content.

2. The method of claim 1, wherein the visual rendering layer is a painting layer of the web browsing application.

3. The method of claim 1, wherein preventing display of the visual content includes preventing the display of the visual content without modifying, in a document object model layer of the web browsing application, code associated with display of the unwanted content.

4. The method of claim 1, wherein preventing display of the visual content includes setting, in a document object model layer, one or more flags instructing the web browsing application to prevent the display of the visual content.

5. The method of claim 1, further comprising:
(i) detecting, based on the user preference data, the unwanted content in a second webpage different from the first webpage, and
(ii) preventing, at the visual rendering layer of the web browsing application, display of the visual content corresponding to the unwanted content in the second webpage.

6. The method of claim 5, wherein detecting the unwanted content in the second webpage includes performing optical character recognition on at least a portion of the second webpage.

7. The method of claim 5, wherein the first webpage differs from the second webpage in respective uniform resource locators (URLs) associated with the first and second webpages.

8. A non-transitory computer readable storage medium configured to store instructions that, when executed by at least one processor included in a computing device, cause the computing device to carry out steps that include, by a web browsing application:
receiving an input identifying unwanted content of a first webpage to be erased from display on a user interface;
storing user preference data identifying the unwanted content;
identifying, based on the unwanted content, visual content corresponding to the unwanted content; and
preventing, at a visual rendering layer of the web browsing application, display of the visual content corresponding to the unwanted content, wherein preventing display of the visual content includes one of (i) preventing the display of the visual content without modifying, in underlying layers of the web browsing application, code associated with display of the unwanted content, or (ii) storing, in one or more of the underlying layers, data instructing the web browsing application to prevent the display of the visual content.

9. A computing device, comprising:
at least one processor; and
at least one memory storing instructions that, when executed by the at least one processor, cause the computing device to carry out steps that include, by a web browsing application:
receiving an input identifying unwanted content of a first webpage to be erased from display on a user interface;
storing user preference data identifying the unwanted content;
identifying, based on the unwanted content, visual content corresponding to the unwanted content; and
preventing, at a visual rendering layer of the web browsing application, display of the visual content corresponding to the unwanted content, wherein preventing display of the visual content includes one of (i) preventing the display of the visual content without modifying, in underlying layers of the web browsing application, code associated with display of the unwanted content, or (ii) storing, in one or more of the underlying layers, data instructing the web browsing application to prevent the display of the visual content.
